(19) United States
(12) Patent Application Publication
(10) Pub. No.: US 2024/0043011 A1
(43) Pub. Date: Feb. 8, 2024

(54) HYBRID ELECTRIC VEHICLE

(71) Applicant: TOYOTA JIDOSHA KABUSHIKI KAISHA, Aichi-ken (JP)

(72) Inventors: Tetsuya SAKUMA, Shizuoka-ken (JP); Ryosuke KAYANUMA, Shizuoka-ken (JP)

(21) Appl. No.: 18/351,493

(22) Filed: Jul. 13, 2023

(30) Foreign Application Priority Data
Aug. 8, 2022 (JP) 2022-126335

(51) Int. Cl. B60W 30/194; B60W 20/15; B60W 10/06

(52) U.S. Cl. CPC B60W 30/194; B60W 20/15; B60W 10/06; B60W 10/08

(57) ABSTRACT

A controller for a hybrid electric vehicle executes an intake gas flow rate adjusting process, a motor-driven actuation process, a fuel vapor adjusting process, and a starting process. The intake gas flow rate adjusting process includes adjusting an opening degree of a throttle valve to an open state. The motor-driven actuation process includes controlling a motor-generator to perform motor-driven actuation of the internal combustion engine. The fuel vapor adjusting process includes adjusting an opening degree of a fuel vapor adjusting valve during the motor-driven actuation process, thereby allowing fuel vapor to flow through a fuel vapor passage. The starting process includes starting the internal combustion engine by controlling an ignition device to perform ignition during the motor-driven actuation process.

### BACKGROUND

### 1. Field

The present disclosure relates to a hybrid electric vehicle.

### 2. Description of Related Art

Japanese Laid-Open Patent Publication No. 2003-343365 discloses a fuel supplying device for an internal combustion engine. The fuel supplying device includes a fuel tank that stores fuel, a fuel vapor passage that delivers fuel vapor generated in the fuel tank to a combustion chamber of the internal combustion engine together with air, and a booster pump provided in the fuel vapor passage. Further, the fuel supplying device includes a controller that controls the booster pump. When the internal combustion engine is started, the controller drives the booster pump to deliver the fuel vapor generated in the fuel tank to the combustion chamber.

In the above-described fuel supplying device, a booster pump is required to supply fuel vapor to the combustion chamber. The use of the booster pump increases the costs. In addition, it is necessary to secure space for mounting the booster pump. Therefore, there is a demand for a technique for supplying fuel vapor to a combustion chamber without necessarily requiring a booster pump when starting an internal combustion engine.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a hybrid electric vehicle includes an internal combustion engine as a drive source, a fuel vapor passage, a fuel vapor adjusting valve, a motor-generator, and a controller. The internal combustion engine includes an engine main body including a combustion chamber, a fuel injection device configured to supply liquid fuel to the combustion chamber, an ignition device configured to ignite the liquid fuel for combustion in the combustion chamber, an intake passage that is connected to the combustion chamber and is configured to deliver an intake gas to the combustion chamber, and a throttle valve that is provided in the intake passage and is configured to adjust an intake gas flow rate that is a flow rate of the intake gas. The fuel vapor passage connects a fuel tank to a section of the intake passage between the throttle valve and the combustion chamber. The fuel vapor passage is configured to deliver fuel vapor generated in the fuel tank to the intake passage together with air. The fuel vapor adjusting valve is provided in the fuel vapor passage and is configured to adjust an opening degree of the fuel vapor passage. The motor-generator is capable of performing a motor-driven actuation, in which the motor-generator rotates a crankshaft of the internal combustion engine without injecting the liquid fuel from the fuel injection device. The controller is configured to control starting of the internal combustion engine by controlling the ignition device, the throttle valve, the fuel vapor adjusting valve, and the motor-generator. The controller is configured to execute an intake gas flow rate adjusting process that controls an opening degree of the throttle valve to an open state, a motor-driven actuation process that controls the motor-generator to perform motor-driven actuation of the internal combustion engine, a fuel vapor adjusting process that adjusts an opening degree of the fuel vapor adjusting valve during the motor-driven actuation process, thereby allowing the fuel vapor to flow through the fuel vapor passage, and a starting process that starts the internal combustion engine by controlling the ignition device to perform ignition during the motor-driven actuation process.

With the above-described configuration, fuel vapor is supplied to the combustion chamber by the negative pressure generated by the motor-driven actuation by the motor. Then, the fuel vapor adjusting process controls the amount of fuel vapor supplied to the combustion chamber to an amount suitable for starting the internal combustion engine. Therefore, when starting the internal combustion engine by burning fuel vapor, it is not necessary to use a device such as a booster pump that is dedicated to supplying fuel vapor.

Other features and aspects will be apparent from the following detailed description, the drawings, and the claims.

### BRIEF DESCRIPTION OF THE DRAWINGS

FIG. 1 is a schematic diagram of a hybrid electric vehicle.

FIG. 2 is a schematic view of the hybrid electric vehicle shown in FIG. 1.

FIG. 3 is a flowchart of a series of processes of an engine starting program, showing a portion including a first starting process.

FIG. 4 is a flowchart of a series of processes of the engine starting program, showing a portion including a second starting process.

FIG. 5 is a flowchart of a series of processes of the engine starting program, showing a process executed when a maximum supply amount does reach a requested mount.

FIG. 6 is a flowchart of a series of processes of the engine starting program, showing a process executed when intake vacuum does not become a required negative pressure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### One Embodiment

A hybrid electric vehicle 100 according to one embodiment will now be described with reference to the drawings.

### Schematic Configuration of Hybrid Electric Vehicle

First, a schematic configuration of the hybrid electric vehicle 100 will be described.

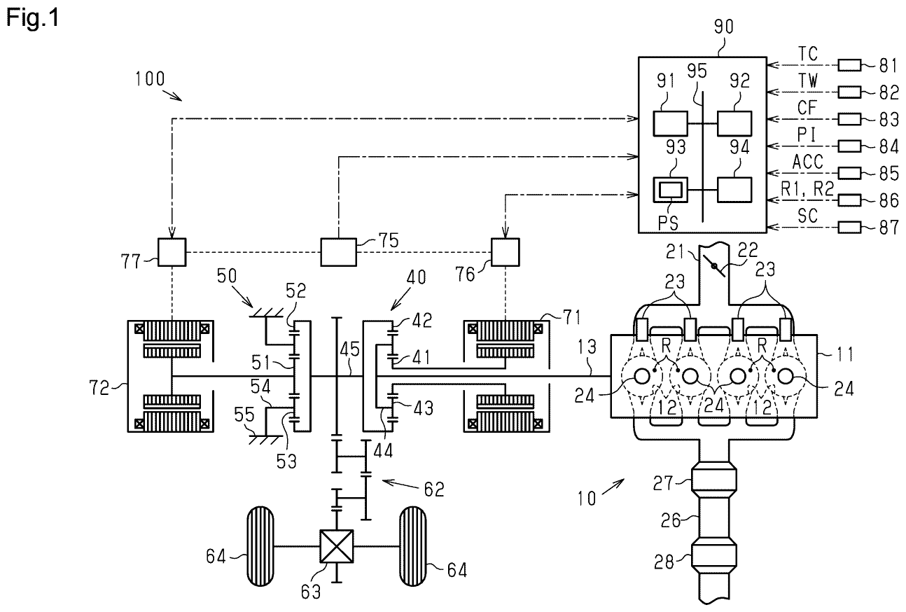

As shown in FIG. 1, the hybrid electric vehicle 100 includes a spark-ignition type internal combustion engine 10 as a drive source. The hybrid electric vehicle 100 also includes a first motor-generator 71 and a second motor-generator 72, each of which functions as both an electric motor and a generator.

The internal combustion engine 10 includes an engine main body 11. The engine main body 11 includes multiple cylinders 12 and a crankshaft 13.

Each cylinder 12 is a space for burning an air-fuel mixture of fuel and intake gas. The engine main body 11 includes four cylinders 12.

The crankshaft 13 is coupled to a piston (not shown) located in each cylinder 12. A space defined by an inner wall of the cylinder 12 and the piston is a combustion chamber R. When fuel is burned in each combustion chamber R, the piston located in the cylinder 12 operates. As a result, the crankshaft 13 coupled to the piston rotates.

The internal combustion engine 10 also includes an intake passage 21, a throttle valve 22, multiple fuel injection devices 23, and ignition devices 24. The internal combustion engine 10 also includes an exhaust passage 26, a catalyst 27, and a filter 28.

The intake passage 21 is connected to the cylinders 12. Part of the intake passage 21 that includes the downstream end is branched into four passages. The branched passages are connected to the respective cylinders 12. The intake passage 21 allows intake gas to flow from the outside of the internal combustion engine 10 to the combustion chambers R.

The throttle valve 22 is located on the upstream side of the branched section of the intake passage 21. The throttle valve 22 adjusts an intake gas flow rate, which the amount of intake gas flowing through the intake passage 21.

The fuel injection devices 23 are located near the downstream end of the intake passage 21. The internal combustion engine 10 includes four fuel injection devices 23 in correspondence with the four cylinders 12. The fuel injection devices 23 inject liquid fuel supplied from a fuel tank 31, which will be discussed below, into the intake passage 21. That is, the fuel injection devices 23 supply fuel to the combustion chambers R via the intake passage 21. The ignition devices 24 are located in the cylinders 12. The internal combustion engine 10 includes four ignition devices 24 in correspondence with the four cylinders 12. The ignition devices 24 ignite mixture of fuel and intake gas by spark discharge to burn the mixture in the combustion chambers R.

The exhaust passage 26 is connected to the cylinders 12. Part of the exhaust passage 26 that includes the upstream end is branched into four passages. The branched passages are connected to the respective cylinders 12. The exhaust passage 26 discharges exhaust gas from the cylinders 12 to the outside of the internal combustion engine 10.

The catalyst 27 is located on the downstream side of the branched section of the exhaust passage 26. The catalyst 27 purifies exhaust gas flowing through the exhaust passage 26. The filter 28 is located on the downstream side of the catalyst 27 in the exhaust passage 26. The filter 28 traps particulate matter that is in the exhaust gas flowing through the exhaust passage 26.

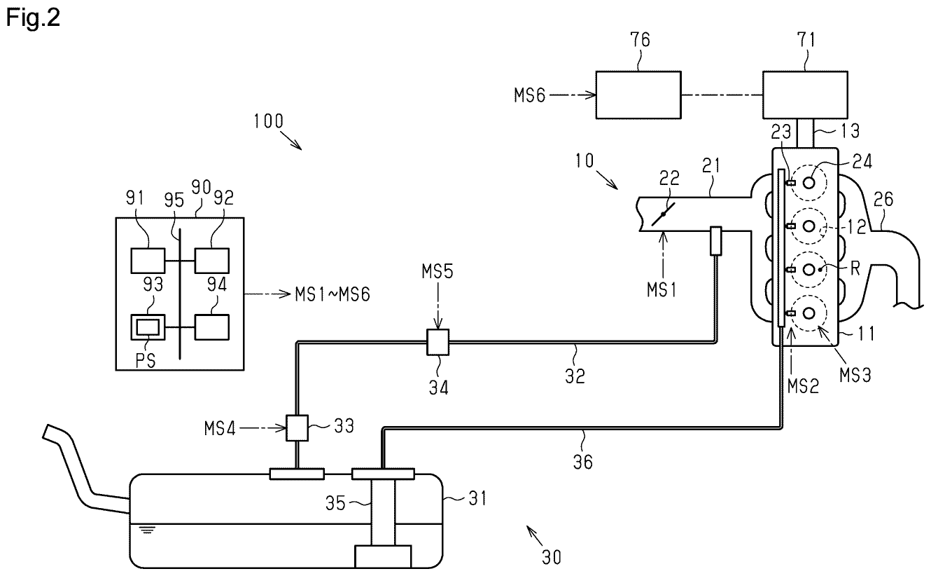

As shown in FIG. 2, the hybrid electric vehicle 100 includes a fuel supply mechanism 30. The fuel supply mechanism 30 includes a fuel tank 31, a fuel vapor passage 32, a shutoff valve 33, and a fuel vapor adjusting valve 34.

The fuel tank 31 stores fuel to be burned in the combustion chambers R. The fuel vapor passage 32 is a passage through which fuel vapor generated in the fuel tank 31 flows into the intake passage 21 together with air. The fuel vapor passage 32 connects the fuel tank 31 to a section of the intake passage 21 on the downstream side of the throttle valve 22 and on the upstream side of the combustion chambers R.

The shutoff valve 33 is mounted in the middle of the fuel vapor passage 32. The shutoff valve 33 is a valve that switches the flow path of the fuel vapor passage 32 between a fully open state and a fully closed state. The fuel vapor adjusting valve 34 is attached to a section of the fuel vapor passage 32 that is on the downstream side of the shutoff valve 33. The fuel vapor adjusting valve 34 adjusts the opening degree of the flow path of the fuel vapor passage 32. The opening degree of the fuel vapor adjusting valve 34 can be continuously changed from a fully open state to a fully closed state. An “open state” includes not only the fully open state but also all opening degrees at which the fuel vapor can flow through the fuel vapor passage 32. That is, the “open state” is a state of the opening degree except for the fully closed state.

The fuel supply mechanism 30 includes a feed pump 35 and a liquid fuel passage 36.

The feed pump 35 is an electric pump that pumps liquid fuel stored in the fuel tank 31. The liquid fuel passage 36 connects the feed pump 35 to the fuel injection device 23. The liquid fuel passage 36 is a passage through which the liquid fuel discharged from the feed pump 35 flows to the fuel injection devices 23.

As shown in FIG. 1, the hybrid electric vehicle 100 includes a first planetary gear mechanism 40, a ring gear shaft 45, a second planetary gear mechanism 50, a speed reduction mechanism 62, a differential mechanism 63, and drive wheels 64.

The first planetary gear mechanism 40 includes a sun gear 41, a ring gear 42, pinions 43, and a carrier 44. The sun gear 41 is an external gear. The sun gear 41 is connected to the first motor-generator 71. The ring gear 42 is an internal gear and is arranged coaxially with the sun gear 41. The pinions 43 are arranged between the sun gear 41 and the ring gear 42. The pinions 43 mesh with both the sun gear 41 and the ring gear 42. The carrier 44 supports the pinions 43. Each pinion 43 is rotatable about its own axis and is allowed to orbit by rotating together with the carrier 44. The carrier 44 is connected to the crankshaft 13.

The ring gear shaft 45 is connected to the ring gear 42. The ring gear shaft 45 is connected to drive wheels 64 via the speed reduction mechanism 62 and the differential mechanism 63. The speed reduction mechanism 62 reduces rotation speed of the ring gear shaft 45 and outputs the rotation. The differential mechanism 63 allows for a difference in rotation speed between the left and right drive wheels 64.

The second planetary gear mechanism 50 includes a sun gear 51, a ring gear 52, pinions 53, a carrier 54, and a case 55. The sun gear 51 is an external gear. The sun gear 51 is connected to the second motor-generator 72. The ring gear 52 is an internal gear and is arranged coaxially with the sun gear 51. The ring gear 52 is connected to the ring gear shaft 45. The pinions 53 are arranged between the sun gear 51 and the ring gear 52. The pinions 53 mesh with both the sun gear 51 and the ring gear 52. The carrier 54 supports the pinions 53. Each pinion 53 is rotatable on its axis. The carrier 54 is fixed to the case 55. The pinions 53 are thus unable to orbit.

The hybrid electric vehicle 100 includes a battery 75, a first inverter 76, and a second inverter 77.

The battery 75 is a rechargeable battery. The first inverter 76 performs AC-DC power conversion between the first motor-generator 71 and the battery 75. The first inverter 76 adjusts the amount of power transferred between the first motor-generator 71 and the battery 75. The second inverter 77 performs AC-DC power conversion between the second motor-generator 72 and the battery 75. The second inverter 77 adjusts the amount of power transferred between the second motor-generator 72 and the battery 75. The first motor-generator 71 is capable of rotating the crankshaft 13 of the engine main body 11 without injecting liquid fuel from the fuel injection devices 23. That is, the first motor-generator 71 is capable of performing motor-driven actuation of the internal combustion engine 10. Motor-driven actuation is also referred to as motoring.

The hybrid electric vehicle 100 includes a catalyst temperature sensor 81, a coolant temperature sensor 82, a fuel vapor concentration sensor 83, a negative pressure sensor 84, an accelerator operation amount sensor 85, and a power switch 86.

The catalyst temperature sensor 81 is attached to a section of the exhaust pas sage 26 that is on the downstream side of the catalyst 27. The catalyst temperature sensor 81 detects a temperature of exhaust gas flowing out from the catalyst 27 as a catalyst temperature TC.

The coolant temperature sensor 82 detects a coolant temperature TW that is a temperature of coolant for cooling the engine main body 11. Although not illustrated, the coolant temperature sensor 82 is attached to an outlet of a water jacket defined inside the engine main body 11. The coolant temperature sensor 82 detects the temperature of the coolant flowing through the water jacket as the coolant temperature TW.

The fuel vapor concentration sensor 83 detects a fuel vapor concentration CF, which indicates the concentration of fuel vapor in the gas filling the fuel tank 31. The fuel vapor concentration sensor 83 is installed inside the fuel tank 31.

The negative pressure sensor 84 is attached to a section of the intake passage 21 that is near the section connected to the fuel vapor passage 32. The negative pressure sensor 84 detects, as an intake negative pressure PI, a negative pressure at the section of the intake passage 21 that is connected to the fuel vapor passage 32. The accelerator operation amount sensor 85 detects an accelerator operation amount ACC, which is an operated amount of an accelerator pedal by a driver.

The power switch 86 is turned on when the power supply of the hybrid electric vehicle 100 is in an OFF state to transmit a start request R1. The power switch 86 is turned off when the power supply of the hybrid electric vehicle 100 is in an ON state to transmit a stop request R2. A crank angle sensor 87 is located near the crankshaft 13. The crank angle sensor 87 detects a rotational phase SC of the crankshaft 13.

### Controller

The hybrid electric vehicle 100 includes a controller 90. The controller 90 controls the hybrid electric vehicle 100. In particular, when executing an engine starting program PS, which will be discussed below, the controller 90 controls the throttle valve 22, the fuel injection devices 23, the ignition devices 24, the shutoff valve 33, the fuel vapor adjusting valve 34, and the first motor-generator 71. The controller 90 obtains a signal indicating the catalyst temperature TC from the catalyst temperature sensor 81. The controller 90 obtains a signal indicating the coolant temperature TW from the coolant temperature sensor 82. The controller 90 obtains a signal indicating the fuel vapor concentration CF from the fuel vapor concentration sensor 83. The controller 90 obtains a signal indicating the intake negative pressure PI from the negative pressure sensor 84. The controller 90 obtains a signal indicating the accelerator operation amount ACC from the accelerator operation amount sensor 85. The controller 90 obtains a signal indicating the start request R1 and a signal indicating the stop request R2 from the power switch 86. The controller 90 obtains a signal indicating the rotational phase SC of the crankshaft 13 from the crank angle sensor 87.

The controller 90 includes a CPU 91, peripheral circuitry 92, a ROM 93, a storage device 94, and a bus 95. The bus 95 communicatively connects the CPU 91, the peripheral circuitry 92, the ROM 93, and the storage device 94 to one another. The peripheral circuitry 92 includes a circuit that generates a clock signal regulating internal operations, a power supply circuit, and a reset circuit. The ROM 93 stores various programs that cause the CPU 91 to execute various control processes. The CPU 91 controls the hybrid electric vehicle 100 by executing various programs stored in the ROM 93. In particular, the ROM 93 stores the engine starting program PS for starting the internal combustion engine 10. The CPU 91 executes the engine starting program PS to control the throttle valve 22, the fuel injection devices 23, the ignition devices 24, the shutoff valve 33, the fuel vapor adjusting valve 34, and the first motor-generator 71, thereby starting the internal combustion engine 10. FIG. 2 shows signals with which the CPU 91 controls these devices as operation signals MS1 to MS6.

### Series of Processes by Engine Starting Program

### Processes in Cold State

When there is a request for starting the internal combustion engine 10 in a state in which the internal combustion engine 10 is stopped, the CPU 91 executes the engine starting program PS. For example, when the hybrid electric vehicle 100 is in an OFF state and the controller 90 obtains a signal indicating the start request R1 from the power switch 86, the CPU 91 determines that there is a request for starting the internal combustion engine 10. When the hybrid electric vehicle 100 is in an OFF state, the shutoff valve 33 is fully closed.

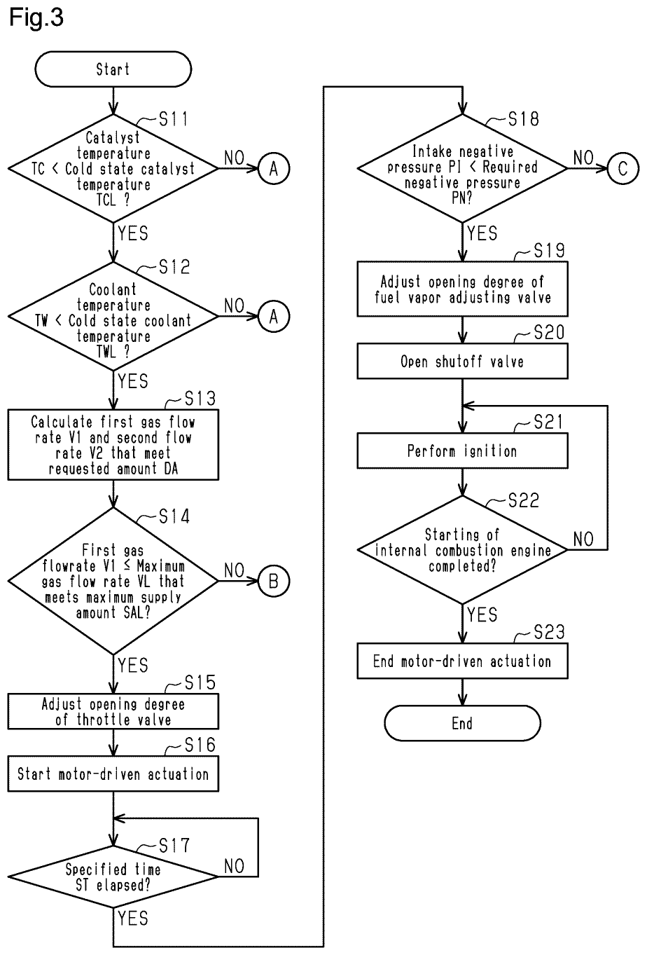

As shown in FIG. 3, when starting a series of processes of the engine starting program PS, the CPU 91 first executes the process of step S11. In step S11, the CPU 91 determines whether the catalyst temperature TC is lower than a cold state catalyst temperature TCL. The cold state catalyst temperature TCL is determined in advance as a value less than an activation temperature of the catalyst 27. When the catalyst temperature TC is lower than the cold state catalyst temperature TCL (S11: YES), the CPU 91 advances the process to step S12.

In step S12, the CPU 91 determines whether the coolant temperature TW is lower than a cold state coolant temperature TWL. The cold state coolant temperature TWL is determined in advance as a temperature for determining whether warm-up of the internal combustion engine 10 has been completed. The cold state coolant temperature TWL is, for example, several tens of degrees. When the coolant temperature TW is lower than the cold state coolant temperature TWL (S12: YES), the CPU 91 advances the process to step S13. That is, in step S12, CPU 91 executes a cold state determining process for determining whether the internal combustion engine 10 is being started in a cold state. When the coolant temperature TW is lower than the cold state coolant temperature TWL, the CPU 91 determines that the internal combustion engine 10 is in a cold state, in which the temperature of the internal combustion engine 10 is less than or equal to a specified temperature that is determined in advance. When the coolant temperature TW is greater than or equal to the cold state coolant temperature TWL, the CPU 91 determines that the internal combustion engine 10 is not in a cold state. The cold state coolant temperature TWL corresponds to the specified temperature.

In step S13, the CPU 91 calculates a first gas flow rate V1 and a second gas flow rate V2. The first gas flow rate V1 is a flow rate of the gas flowing through the fuel vapor passage 32 that is required when a first starting process, which will be discussed below, is executed in the current series of processes. The second gas flow rate V2 is a flow rate of the gas flowing through the intake passage 21 in the current series of processes. The first gas flow rate V1 is a flow rate of gas flowing through the fuel vapor passage 32 that is required when the torque required for starting the internal combustion engine 10 is provided by fuel vapor alone. That is, when the gas at the first gas flow rate V1 flows through the fuel vapor passage 32, the mass of the fuel vapor supplied to the intake passage 21 per unit time agrees with a requested amount DA, which is the mass of the fuel per unit time required for the current starting of the internal combustion engine 10. The requested amount DA is determined in advance through tests and simulations. In step S13, the CPU 91 calculates the first gas flow rate V1 based on the signal indicating the fuel vapor concentration CF from the fuel vapor concentration sensor 83. Specifically, the CPU 91 calculates the first gas flow rate V1 to be a smaller value as the fuel vapor concentration CF increases.

The second gas flow rate V2 is a flow rate of gas flowing through the intake passage 21 required to bring the air-fuel ratio of the gas supplied to the combustion chambers R to a target air-fuel ratio when the flow rate of the gas flowing through the fuel vapor passage 32 is set to the first gas flow rate V1. The target air-fuel ratio is, for example, the stoichiometric air-fuel ratio. Thereafter, the CPU 91 advances the process to step S14.

In step S14, the CPU 91 determines whether the requested amount DA, which is the mass of fuel required per unit time, can be supplied by the fuel vapor alone at the time of the current starting of the internal combustion engine 10. The mass of the fuel vapor supplied to the intake passage 21 per unit time when the fuel vapor adjusting valve 34 is fully opened is defined as a maximum supply amount SAL. If the requested amount DA is smaller than or equal to the maximum supply amount SAL, the fuel can be supplied by the fuel vapor alone.

Specifically, the CPU 91 compares the first gas flow rate V1, which is calculated in step S13, with a maximum gas flow rate VL, which is the maximum gas flow rate that can flow through the fuel vapor passage 32. When the first gas flow rate V1 is less than or equal to the maximum gas flow rate VL, the CPU 91 determines that the requested amount DA can be supplied by the fuel vapor alone. The maximum gas flow rate VL is a maximum gas flow rate that can flow through the fuel vapor passage 32 when the opening degree of the fuel vapor adjusting valve 34 is fully opened. When the first gas flow rate V1 is less than or equal to the maximum gas flow rate VL (S14: YES), the CPU 91 advances the process to step S15.

In step S15, the CPU 91 executes an intake gas flow rate adjusting process. In the intake gas flow rate adjusting process, the CPU 91 controls the throttle valve 22 to adjust the opening degree of the throttle valve 22 to an open state. In step S15, the CPU 91 adjusts the opening degree of the throttle valve 22 such that the gas flow rate through the intake passage 21 becomes the second gas flow rate V2. That is, the CPU 91 adjusts the opening degree of the throttle valve 22 such that a value obtained by dividing the mass of air supplied to the combustion chambers R per unit time by the requested amount DA becomes the target air-fuel ratio. Thereafter, the CPU 91 advances the process to step S16.

In step S16, the CPU 91 starts a motor-driven actuation process. In the motor-driven actuation process, the CPU 91 controls the first motor-generator 71 to perform motor-driven actuation of the internal combustion engine 10. Specifically, the CPU 91 controls the first motor-generator 71 via the first inverter 76 to apply torque from the first motor-generator 71 to the crankshaft 13. The CPU 91 rotates the crankshaft 13 at a predetermined speed with the torque from the first motor-generator 71. This generates a negative pressure in each combustion chamber R. The CPU 91 continues the motor-driven actuation process even after step S16. Thereafter, the CPU 91 advances the process to step S17.

In step S17, the CPU 91 determines whether a specified time ST, which is determined in advance, has elapsed since the start of the motor-driven actuation process. The specified time ST is determined through tests and/or simulations as a time required for negative pressure in each combustion chamber R to reach a predetermined required negative pressure PN after the start of the motor-driven actuation process. The required negative pressure PN is used as a pressure at which gas can be sufficiently supplied from the fuel vapor passage 32. If the specified time ST has not elapsed (S17), the CPU 91 repeats the process of step S17. If the specified time ST has elapsed (S17), the CPU 91 advances the process to step S18.

In step S18, the CPU 91 determines whether the intake negative pressure PI is lower than the required negative pressure PN. When the intake negative pressure PI is lower than the required negative pressure PN, the CPU 91 advances the process to step S19.

In step S19, the CPU 91 performs a fuel vapor adjusting process. In the fuel vapor adjusting process, the CPU 91 adjusts the opening degree of the fuel vapor adjusting valve 34 during the motor-driven actuation process, thereby allowing fuel vapor to flow through the fuel vapor passage 32. The CPU 91 adjusts the opening degree of the fuel vapor adjusting valve 34 such that the mass of the fuel vapor supplied to the intake passage 21 per unit time approaches the requested amount DA. Specifically, the CPU 91 adjusts the opening degree of the fuel vapor adjusting valve 34 such that the gas flow rate through the fuel vapor passage 32 becomes the first gas flow rate V1. Therefore, when step S19 is executed, the mass of the fuel vapor supplied to the intake passage 21 per unit time agrees with the requested amount DA. Thereafter, the CPU 91 advances the process to step S20.

In step S20, the CPU 91 changes the shutoff valve 33 from the fully closed state to the fully open state. Thereafter, the CPU 91 advances the process to step S21.

In step S21, the CPU 91 performs the first starting process. In the first starting process, the CPU 91 starts the internal combustion engine 10 by controlling the ignition devices 24 to perform ignition during the motor-driven actuation process continued after step S16. Thereafter, the CPU 91 advances the process to step S22.

In step S22, the CPU 91 determines whether the starting of the internal combustion engine 10 has been completed. Specifically, the CPU 91 first calculates the rotation speed of the crankshaft 13 based on the rotational phase SC of the crankshaft 13. Next, the CPU 91 determines whether the rotation speed of the crankshaft 13 is greater than or equal to a specified rotation speed, which is determined in advance. The specified rotation speed is determined in advance through tests and simulations as a rotation speed of the crankshaft 13 at which starting of the internal combustion engine 10 is regarded to be completed. When starting of the internal combustion engine 10 has not been completed (S22: NO), the CPU 91 returns the process to step S20. When starting of the internal combustion engine 10 is completed (S22: YES), the CPU 91 advances the process to step S23.

In step S23, the CPU 91 ends the motor-driven actuation process. Specifically, the CPU 91 stops applying torque from the first motor-generator 71 to the crankshaft 13. Thereafter, the CPU 91 ends the series of processes.

### Processes in Non-Cold State

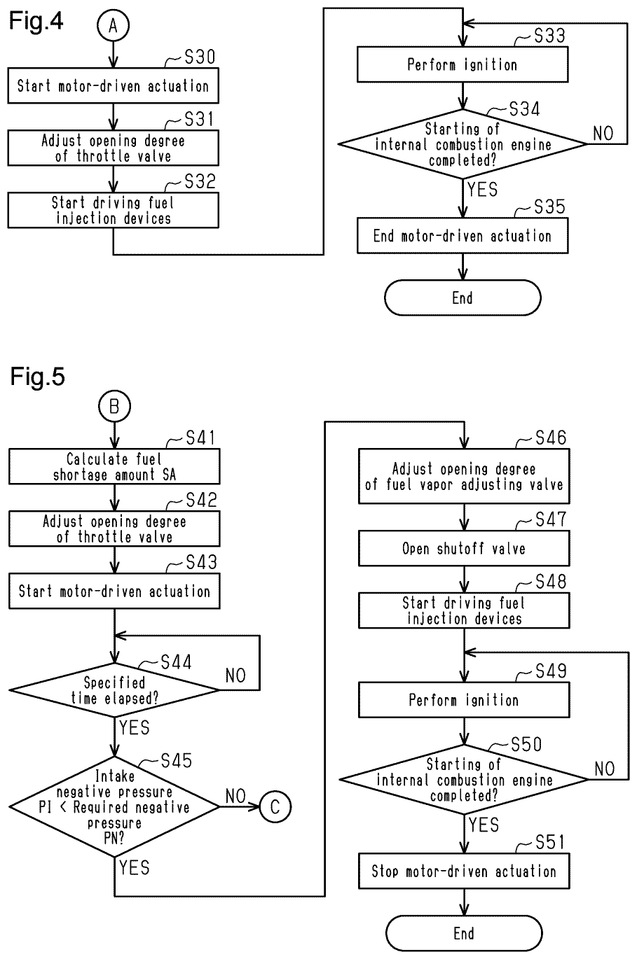

When a negative determination is made in step S11 or step S12 shown in FIG. 3, the CPU 91 advances the process to step S30 shown in FIG. 4. Specifically, when the catalyst temperature TC is greater than or equal to the cold state catalyst temperature TCL (S11: NO), or when the coolant temperature TW is greater than or equal to the cold state coolant temperature TWL, the CPU 91 advances the process to step S30. That is, when the catalyst 27 is in an activated state or when the internal combustion engine 10 is not in a cold state, the CPU 91 advances the process to step S30.

As shown in FIG. 4, the CPU 91 starts the motor-driven actuation process in step S30. In the motor-driven actuation process, the CPU 91 controls the first motor-generator 71 to perform motor-driven actuation of the internal combustion engine 10. The process of step S30 is the same as the process of step S16 described above. The CPU 91 continues the motor-driven actuation process after step S30. Thereafter, the CPU 91 advances the process to step S31.

In step S31, the CPU 91 executes the intake gas flow rate adjusting process. The CPU 91 controls the throttle valve 22 to adjust the opening degree of the throttle valve 22 to an open state. In step S31, the opening degree of the throttle valve 22 is adjusted such that a value obtained by dividing the mass of air supplied to the combustion chambers R per unit time by the requested amount DA becomes the target air-fuel ratio. In step S31, the gas flow rate through the intake passage 21 becomes higher than the second gas flow rate V2 by an amount corresponding to the absence of air supplied from the fuel vapor passage 32 to the intake passage 21. Therefore, the opening degree of the throttle valve 22 becomes a value larger than the opening degree of the throttle valve 22 in step S15. Thereafter, the CPU 91 advances the process to step S32.

In step S32, the CPU 91 starts driving the fuel injection devices 23. The CPU 91 drives the fuel injection devices 23 so as to supply liquid fuel to the combustion chambers R by the requested amount DA. Thereafter, the CPU 91 advances the process to step S33.

In step S33, the CPU 91 performs a second starting process. In the second starting process, the CPU 91 starts the internal combustion engine 10 by driving the fuel injection devices 23 to supply liquid fuel to the combustion chambers R and controlling the ignition devices 24 to perform ignition. Thereafter, the CPU 91 advances the process to step S34.

In step S34, the CPU 91 determines whether the starting of the internal combustion engine 10 has been completed. The details are the same as those of step S22. When starting of the internal combustion engine 10 has not been completed (S34: NO), the CPU 91 returns the process to step S33. When starting of the internal combustion engine 10 is completed (S34: YES), the CPU 91 advances the process to step S35.

In step S35, the CPU 91 ends the motor-driven actuation process. Specifically, the CPU 91 stops applying torque from the first motor-generator 71 to the crankshaft 13. Thereafter, the CPU 91 ends the series of processes.

In this manner, when the internal combustion engine 10 is not in a cold state, the CPU 91 starts the internal combustion engine 10 by executing the second starting process without executing the fuel vapor adjusting process during the motor-driven actuation process or the first starting process.

### Processes when Maximum Supply Amount is Smaller than Requested Amount

When a negative determination is made in step S14 shown in FIG. 3, the CPU 91 advances the process to step S41 shown in FIG. 5. Specifically, when the first gas flow rate V1 is larger than the maximum gas flow rate VL (S14: NO), the CPU 91 advances the process to step S41. That is, when the maximum supply amount SAL is smaller than the requested amount DA, the CPU 91 advances the process to step S41.

As shown in FIG. 5, in step S41, the CPU 91 calculates a fuel shortage amount SA. Specifically, the CPU 91 calculates the fuel shortage amount SA by subtracting the maximum supply amount SAL from the requested amount DA. Thereafter, the CPU 91 advances the process to step S42.

In step S42, the CPU 91 executes an intake gas flow rate adjusting process. The CPU 91 controls the throttle valve 22 to adjust the opening degree of the throttle valve 22 to an open state. In step S42, the opening degree of the throttle valve 22 is adjusted such that a value obtained by dividing the mass of air supplied to the combustion chambers R per unit time by the requested amount DA becomes the target air-fuel ratio. Thereafter, the CPU 91 advances the process to step S43.

The processes from step S43 to step S47 are the same as those from step S16 to step S20 described above. Thus, detailed explanation for these processes is omitted. In step S46, the opening degree of the fuel vapor adjusting valve 34 is fully opened. Therefore, the mass of fuel vapor supplied to the intake passage 21 per unit time becomes the maximum supply amount SAL. Therefore, although the mass of fuel vapor supplied to the intake passage 21 per unit time does not agree with the requested amount DA, it is brought as close to the requested amount DA as possible. After step S47, the CPU 91 advances the process to step S48.

In step S48, the CPU 91 executes an additional injection process. Specifically, the CPU 91 starts driving the fuel injection devices 23. Then, the CPU 91 drives the fuel injection devices 23 so as to supply liquid fuel to the combustion chambers R by the fuel shortage amount SA per unit time. Thereafter, the CPU 91 advances the process to step S49.

The processes of steps S49 to S51 are the same as the processes of steps S21 to S23. Thus, detailed explanation for these processes is omitted. After step S51, the CPU 91 ends the series of processes.

### Processes when Intake Negative Pressure does not become Required Negative Pressure

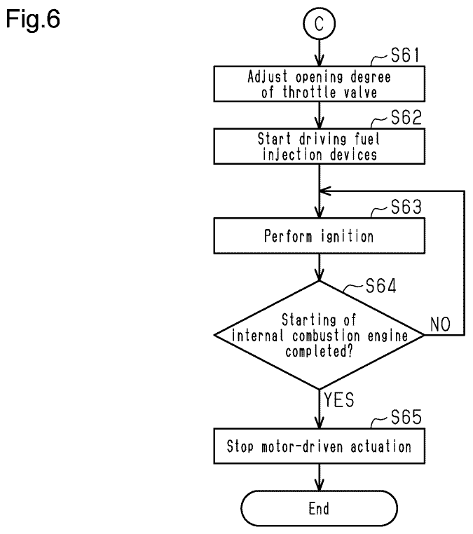

When a negative determination is made in step S18 shown in FIG. 3 or when a negative determination is made in step S45 shown in FIG. 5, the CPU 91 advances the process to step S61 shown in FIG. 6. Specifically, when the intake negative pressure PI is not reduced to the required negative pressure PN, the CPU 91 advances the process to step S61.

As shown in FIG. 6, the CPU 91 executes an intake gas flow rate adjusting process in step S61. The processes of steps S61 to S65 are the same as the processes of steps S31 to S35. Thus, detailed explanation for these processes is omitted. After the process of step S65, the CPU 91 ends the series of processes.

### Operation of Embodiment

With the above-described embodiment, when the CPU 91 starts the motor-driven actuation process, the first motor-generator 71 performs motor-driven actuation of the internal combustion engine 10. This generates a negative pressure in each combustion chamber R. Then, when the specified time ST elapses, the intake negative pressure PI becomes lower than the required negative pressure PN. The intake negative pressure PI causes air to flow from the fuel vapor passage 32 to the intake passage 21 together with fuel vapor.

### Advantages of Embodiment

(1) With the above-described embodiment, the first motor-generator 71 performs motor-driven actuation of the internal combustion engine 10, thereby generating the intake negative pressure PI. The intake negative pressure PI causes fuel vapor to be supplied to the combustion chambers R. Then, the fuel vapor adjusting process controls the amount of fuel vapor supplied to the combustion chambers R to an amount suitable for starting the internal combustion engine 10. Therefore, when starting the internal combustion engine 10 by burning fuel vapor, it is not necessary to use a device such as a booster pump that is dedicated to supplying fuel vapor.
(2) With the above-described embodiment, the fuel vapor adjusting process adjusts the opening degree of the fuel vapor adjusting valve 34 such that the mass of the fuel vapor supplied to the intake passage 21 per unit time approaches the requested amount DA. Further, the intake gas flow rate adjusting process adjusts the opening degree of the throttle valve 22 such that a value obtained by dividing the mass of air supplied to the combustion chambers R per unit time by the requested amount DA becomes the target air-fuel ratio. Therefore, the intake gas flow rate adjusting process and the fuel vapor adjusting process supply air and fuel vapor to the combustion chambers R such that the air-fuel ratio becomes the target air-fuel ratio. This prevents the air-fuel ratio from becoming significantly lean or significantly rich at the starting of the internal combustion engine 10.
(3) With the above-described embodiment, when the maximum supply amount SAL is smaller than the requested amount DA, the CPU 91 executes the additional injection process. The additional injection process supplies liquid fuel to the combustion chambers R when the fuel vapor is insufficient for the requested amount DA. This prevents the fuel from being insufficient when starting the internal combustion engine 10.
(4) In the additional injection process of the above-described embodiment, the CPU 91 drives the fuel injection devices 23 so as to supply liquid fuel to the combustion chambers R by the fuel shortage amount SA per unit time. That is, when the internal combustion engine 10 is started, liquid fuel is added in an amount sufficient for the requested amount DA even if fuel vapor alone is insufficient for the requested amount DA. As a result, when the internal combustion engine 10 is started, an appropriate amount of fuel that corresponds to the requested amount DA is supplied.
(5) When the internal combustion engine 10 is in a cold state, the heavy component of the fuel is present as liquid fuel. At this time, if the internal combustion engine 10 is started by using the liquid fuel, the combustion may be unstable or discharge harmful substances. In the above-described embodiment, when the internal combustion engine 10 is in a cold state, the internal combustion engine 10 is started by using fuel vapor. This allows the internal combustion engine 10 to be started by using a fuel vapor containing a small amount of heavy components.

When the internal combustion engine 10 is not in a cold state, the heavy components of the fuel are less likely to be present as liquid fuel, and thus combustion is unlikely to be unstable or discharge harmful substances. With the above-described embodiment, when the internal combustion engine 10 is not in a cold state, the CPU 91 executes the second starting process without executing the fuel vapor adjusting process during the motor-driven actuation process or the first starting process. That is, when the internal combustion engine 10 is in a cold state, the internal combustion engine 10 is started without using fuel vapor. In this case, liquid fuel is supplied both before and after the starting of the internal combustion engine 10. Therefore, the fuel can be supplied without largely changing the property of the fuel before and after the completion of the starting of the internal combustion engine 10.

### Other Embodiments

The above-described embodiment may be modified as follows. The above-described embodiment and the following modifications can be combined if the combined modifications remain technically consistent with each other.

In the internal combustion engine 10, the fuel injection devices 23 may be devices that directly inject liquid fuel into the combustion chambers R, or may be a device that injects liquid fuel into the intake passage 21 and supplies the injected liquid fuel to the combustion chambers R together with intake gas.

The fuel supply mechanism 30 does not necessarily include the shutoff valve 33. Even if the shutoff valve 33 is omitted, the flow rate of the gas flowing through the fuel vapor passage 32 can be adjusted by adjusting the opening degree of the fuel vapor adjusting valve 34.

The fuel supply mechanism 30 may further include a vaporization promoting device. The vaporization promoting device is located inside the fuel tank 31 and promotes vaporization of the liquid fuel in the fuel tank 31. For example, the vaporization promoting device may be a device that promotes vaporization of the liquid fuel with ultrasonic waves.

The fuel tank 31 may have a vaporization chamber for storing fuel vapor in addition to the storage chamber for storing liquid fuel. In a case in which the fuel tank 31 includes only the storage chamber, if the entire space of the storage chamber is filled with liquid fuel, there would be no space in which fuel vapor can exist. In this regard, since liquid fuel is not stored in the vaporization chamber, a corresponding amount of the fuel vapor can be present in the fuel tank 31.

In the fuel supply mechanism 30, the fuel vapor passage 32 may be branched in accordance with the number of the combustion chambers R. In this example, the respective branches of the fuel vapor passage 32 may be connected to the respective branches of the intake passage 21. Further, in this modification, an on-off valve may be provided in each branch of the fuel vapor passage 32. Thus, the fuel vapor can be supplied to each combustion chamber R at an appropriate timing.

The controller 90 may include circuitry including one or more processors that perform various processes according to computer programs (software). The controller 90 may be circuitry including one or more dedicated hardware circuits such as application specific integrated circuits (ASIC) that execute at least part of various processes, or a combination thereof. The processor includes a CPU and a memory such as a RAM and a ROM. The memory stores program codes or instructions configured to cause the CPU to execute processes. Memory or computer-readable media includes any available media that can be accessed by a general purpose or special purpose computer.

The controller 90 may obtain the fuel vapor concentration CF without using the fuel vapor concentration sensor 83. For example, a case is considered in which the storage device 94 stores the vapor pressure characteristics of the liquid fuel stored in the fuel tank 31 in advance, and the hybrid electric vehicle 100 includes a tank temperature sensor that detects the temperature in the fuel tank 31. In this case, the CPU 91 may obtain the fuel vapor concentration CF based on the vapor pressure characteristics of the liquid fuel and the temperature in the fuel tank 31. Further, for example, a case is considered in which the hybrid electric vehicle 100 includes a pressure sensor that detects the pressure in the fuel tank 31 and an oxygen concentration sensor that detects the oxygen concentration in the fuel tank 31. In this case, the CPU 91 may detect the fuel vapor concentration CF through calculation based on the pressures in the fuel tank 31 and the oxygen concentration in the fuel tank 31.

The CPU 91 may start the engine starting program PS when there is a request to start the internal combustion engine 10 while the hybrid electric vehicle 100 is traveling with the first motor-generator 71 and the second motor-generator 72. In this case, since the accelerator operation amount ACC is detected to be large, the possibility that the first gas flow rate V1 is calculated to be large increases. Therefore, in such a case, it is easy to obtain the effect of performing the process in the case in which the maximum supply amount V1 is smaller than the first gas flow rate SAL.

In the fuel vapor adjusting process in step S19, when the opening degree of the fuel vapor adjusting valve 34 is adjusted, the CPU 91 does not necessarily cause the mass of fuel vapor per unit time to agree with the requested amount DA. In the fuel vapor adjusting process, even if the mass of fuel vapor per unit time does not agree with the requested amount DA, the CPU 91 may adjust the opening degree of the fuel vapor adjusting valve 34 in the process of step S19 such that the mass of fuel vapor per unit time approaches the requested amount DA. Further, in the fuel vapor adjusting process, the CPU 91 may adjust the opening degree of the fuel vapor adjusting valve 34 regardless of the requested amount DA. For example, in the fuel vapor adjusting process, the CPU 91 may adjust the opening degree of the fuel vapor adjusting valve 34 to a predetermined fixed opening degree suitable for starting the internal combustion engine 10.

In the intake gas flow rate adjusting process in step S15, the CPU 91 may adjust the opening degree of the throttle valve 22 regardless of the requested amount DA. For example, in the intake gas flow rate adjusting process, the CPU 91 may adjust the opening degree of the throttle valve 22 to a predetermined fixed opening degree suitable for starting the internal combustion engine 10.

In the additional injection process, the CPU 91 does not necessarily need to supply liquid fuel from the fuel injection devices 23 by the fuel shortage amount SA. When the maximum supply amount SAL is smaller than the requested amount DA, it is possible to suppress the degree of fuel shortage even if a small amount of liquid fuel is supplied from the fuel injection devices 23.

In the fuel injection devices 23, there is a minimum amount of fuel injection that ensures an accurate fuel injection amount. When the minimum fuel injection amount per combustion cycle that can be supplied by each fuel injection device 23 is defined as a minimum injection amount, the value obtained by adding the amount that can be supplied per unit time at the minimum injection amount to the maximum supply amount SAL may exceed the requested amount DA. In this case, in the additional injection process, the CPU 91 may supply liquid fuel to the combustion chambers R at the minimum injection amount. In the intake gas adjusting process, the CPU 91 may adjust the opening degree of the throttle valve 22 such that the mass of the fuel vapor supplied to the intake passage 21 per unit time becomes a value obtained by subtracting the amount that can be supplied per unit time at the minimum injection amount from the requested amount DA. With this configuration, the total amount of liquid fuel and fuel vapor supplied to the combustion chambers R becomes the requested amount DA. Therefore, even when liquid fuel is supplied to the combustion chambers R by the additional injection process, combustion can be performed at the target air-fuel ratio.

When the maximum supply amount SAL is smaller than the requested amount DA, the CPU 91 does not necessarily execute the additional injection process. In this case, when the maximum supply amount SAL is smaller than the requested amount DA, the CPU 91 may start the internal combustion engine 10 with liquid fuel alone without using fuel vapor. That is, the CPU 91 may execute the second start-up process when the maximum supply amount SAL is smaller than the requested amount DA.

In the above-described embodiment, the CPU 91 may perform the first start-up processing regardless of the result of the cold state determining processing. In addition, the CPU 91 does not necessarily need to execute the cold state determining process.

The system of the hybrid electric vehicle 100 is not limited to the example of the above-described embodiment is motor-driven actuation of the internal combustion engine 10 can be performed by rotating the crankshaft 13 with a motor-generator.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A hybrid electric vehicle, comprising:
an internal combustion engine as a drive source, the internal combustion engine including:
an engine main body including a combustion chamber;
a fuel injection device configured to supply liquid fuel to the combustion chamber;
an ignition device configured to ignite the liquid fuel for combustion in the combustion chamber;
an intake passage that is connected to the combustion chamber and is configured to deliver an intake gas to the combustion chamber; and
a throttle valve that is provided in the intake passage and is configured to adjust an intake gas flow rate that is a flow rate of the intake gas;
a fuel vapor passage that connects a fuel tank to a section of the intake passage between the throttle valve and the combustion chamber, the fuel vapor passage being configured to deliver fuel vapor generated in the fuel tank to the intake passage together with air;
a fuel vapor adjusting valve that is provided in the fuel vapor passage and is configured to adjust an opening degree of the fuel vapor passage;
a motor-generator that is capable of performing a motor-driven actuation, in which the motor-generator rotates a crankshaft of the internal combustion engine without injecting the liquid fuel from the fuel injection device; and
a controller that is configured to control starting of the internal combustion engine by controlling the ignition device, the throttle valve, the fuel vapor adjusting valve, and the motor-generator,
wherein the controller is configured to execute
an intake gas flow rate adjusting process that controls an opening degree of the throttle valve to an open state,
a motor-driven actuation process that controls the motor-generator to perform motor-driven actuation of the internal combustion engine,
a fuel vapor adjusting process that adjusts an opening degree of the fuel vapor adjusting valve during the motor-driven actuation process, thereby allowing the fuel vapor to flow through the fuel vapor passage, and
a starting process that starts the internal combustion engine by controlling the ignition device to perform ignition during the motor-driven actuation process.

2. The hybrid electric vehicle according to claim 1, wherein
the fuel vapor adjusting process includes adjusting the opening degree of the fuel vapor adjusting valve such that a mass of the fuel vapor supplied to the intake passage per unit time approaches a requested amount, the requested amount being a mass of fuel requested per unit time to start the internal combustion engine, and
the intake gas flow rate adjusting process includes adjusting the opening degree of the throttle valve such that a value obtained by dividing a mass of air supplied to the combustion chamber by the requested amount becomes a target air-fuel ratio.

3. The hybrid electric vehicle according to claim 2, wherein
a mass of the fuel vapor per unit time supplied to the intake passage when the opening degree of the fuel vapor adjusting valve is fully opened is defined as a maximum supply amount, and
the controller is configured to execute an additional injection process in addition to the fuel vapor adjusting process when the maximum supply amount is smaller than the requested amount, the additional injection process supplying the fuel to the combustion chamber by driving the fuel injection device.

4. The hybrid electric vehicle according to claim 3, wherein the additional injection process includes supplying an amount obtained by subtracting the maximum supply amount from the requested amount from the fuel injection device per unit time.

5. The hybrid electric vehicle according to claim 3, wherein
a minimum fuel injection amount per combustion cycle that can be supplied by the fuel injection device is defined as a minimum injection amount, and
when a value obtained by adding an amount that can be supplied per unit time at the minimum injection amount to the maximum supply amount exceeds the requested amount,
the additional injection process includes supplying the fuel to the combustion chamber at the minimum injection amount, and
the fuel vapor adjusting process includes adjusting the opening degree of the throttle valve such that a mass of the fuel vapor supplied to the intake passage per unit time becomes a value obtained by subtracting an amount that can be supplied per unit time at the minimum injection amount from the requested amount.

6. The hybrid electric vehicle according to claim 1, wherein
the starting process is defined as a first starting process
the controller is configured to further execute a cold state determining process that determines whether the internal combustion engine is in a cold state in which a temperature of the internal combustion engine is less than or equal to a specified temperature determined in advance,
the controller is configured to execute the motor-driven actuation process, the fuel vapor adjusting process during the motor-driven actuation process, and the first starting process when it is determined that the internal combustion engine is in the cold state in the cold state determining process, and
the controller is configured to execute a second starting process when it is determined that the internal combustion engine is not in the cold state in the cold state determining process, the second starting process starting the internal combustion engine by controlling the ignition device to perform ignition while driving the fuel injection device to supply the liquid fuel to the combustion chamber, without executing the fuel vapor adjusting process during the motor-driven actuation process or the first starting process.
